(19) United States
(12) Patent Application Publication
(10) Pub. No.: US 2026/0131532 A1
(43) Pub. Date: May 14, 2026

(54) 3D-PRINTING UNMANNED AERIAL VEHICLE

(71) Applicant: KING FAHD UNIVERSITY OF PETROLEUM AND MINERALS, Dhahran (SA)

(72) Inventor: Samir MEKID, Dhahran (SA)

(73) Assignee: KING FAHD UNIVERSITY OF PETROLEUM AND MINERALS, Dhahran (SA)

(21) Appl. No.: 18/945,294

(22) Filed: Nov. 12, 2024

(30) Foreign Application Priority Data
Nov. 10, 2024 (SA) 1020246298

(51) Int. Cl. B29C 64/227; B29C 64/118; B29C 64/209; B29C 64/245; B29C 64/30; B29C 64/393; B33Y 10/00; B33Y 30/00; B33Y 40/20; B33Y 50/02; B33Y 99/00; B64U 10/14; B64U 20/77; B64U 101/26

(52) U.S. Cl. CPC B29C 64/227; B29C 64/118; B29C 64/209; B29C 64/30; B29C 64/393; B33Y 30/00; B33Y 40/00; B33Y 50/02; B33Y 99/00; B64U 10/16; B64U 30/29; B64U 2101/26

(57) ABSTRACT

A 3D-printing unmanned aerial vehicle (UAV) and method of printing a 3D model using the UAV includes a parallel kinematic machine (PKM) mounted on the bottom of a central body of the UAV. The PKM includes a base platform, a moving platform, and a plurality of link members connecting the moving platform to the base platform. The link members are arranged parallel to each other. Printing nozzles are mounted on the moving platform. A control system is provided for controlling the movement of the moving platform for the printing nozzles to deposit material to print a 3D structure at a target area according to a 3D model.

### CROSS-REFERENCE TO RELATED APPLICATION

The present disclosure claims the benefit of Saudi patent application No. 1020246298, filed on Nov. 10, 2024 with the Saudi Authority for Intellectual Property Office, which is incorporated herein by reference in its entirety.

### BACKGROUND

### Technical Field

The present disclosure relates to the field of unmanned aerial vehicles (UAVs) and three-dimensional (3D) printing. More specifically, the present disclosure pertains to a UAV equipped with a parallel kinematic machine (PKM) for 3D printing applications in remote or hard-to-access locations.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Additive manufacturing, commonly known as 3D printing, has revolutionized various industries by enabling rapid prototyping and on-demand production of complex parts. However, traditional 3D printing systems are often limited to controlled environments, such as workshops or factories. This limitation poses challenges when repairs or part replacements are needed in remote locations, hazardous environments, or areas with limited accessibility. Further, unmanned aerial vehicles (UAVs), or drones, have gained widespread use in various applications, including surveillance, delivery, and inspection tasks. The versatility and maneuverability of UAVs make them ideal platforms for extending the reach of 3D printing technology beyond traditional boundaries. UAVs equipped with 3D printing systems have the potential to revolutionize various industries by enabling on-site manufacturing, repair, and maintenance. These UAVs can be configured to travel to specific locations, deposit material, and construct 3D structures based on pre-defined models.

Existing attempts to combine UAVs with 3D printing capabilities have faced several challenges, including limited payload capacity, reduced stability during printing operations, and insufficient precision in depositing materials. In particular, traditional UAVs with 3D printing capabilities often struggle with stability and precision during the printing process, particularly when hovering or navigating in adverse environmental conditions. Additionally, the integration of 3D printing mechanisms with UAVs often leads to increased weight and complexity, affecting flight performance and battery life. Another significant problem is the limited ability to print complex structures or perform repairs in hard-to-reach areas, as conventional systems lack the necessary flexibility and adaptability.

For instance, CN115520406A describes an unmanned aerial vehicle that can be fitted with a variety of tools, including a 3D printing tool. The unmanned aerial vehicle includes a multi-axis parallel arm arrangement with a central plate, which is fitted under a central body thereof. The 3D printing tool is fitted to the central plate and is supported within the multi-axis parallel arm arrangement. This reference discusses an unmanned aerial vehicle with 3D printing capability; however, it does not disclose an unmanned aerial vehicle with a base platform and a movable platform connected by link members being telescopic arms, printing nozzles mounted under the movable platform, or wings of the unmanned aerial vehicle having a U-shaped cross section.

US20180134387A1 describes an aerial device capable of controlled flight. The aerial device comprises a first body that includes a lift generator for providing lift to the aerial device, and a second body that includes a substance dispenser for controllably dispensing a curable substance for additive manufacturing. The aerial device further comprises an articulated coupling assembly that couples the first body to the second body, and an actuator operable to articulate the articulated coupling assembly, thereby moving the second body and the substance dispenser relative to the first body. This reference discusses an aerial device with 3D printing capability; however, it does not disclose an unmanned aerial vehicle with a base platform and a movable platform connected by link members being telescopic arms, printing nozzles mounted under the movable platform, or wings of the unmanned aerial vehicle having a U-shaped cross section.

US20200094958A1 describes an aerial drone designed for repairing holes or punctures in a membrane on a roof. The aerial drone comprises at least one camera for recording a section of the membrane and a 3D printer adapted to print onto the section of the membrane. The 3D printer is controllable wirelessly from a different altitude and/or the ground. The aerial drone further includes at least one on-board communication unit, which is adapted to wirelessly receive commands for the 3D printer from a ground-based communication unit and/or transfer the commands to the 3D printer, as well as receive recordings from the camera and wirelessly send the recordings to the ground-based communication unit. This reference discusses an aerial drone with 3D printing capability; however, it does not disclose an unmanned aerial vehicle with a base platform and a movable platform connected by link members being telescopic arms, printing nozzles mounted under the movable platform, or wings of the unmanned aerial vehicle having a U-shaped cross section.

Accordingly, it is one object of the present disclosure to provide an unmanned aerial vehicle (UAV) that can effectively incorporate 3D printing capabilities without sacrificing flight performance or print quality. The present disclosure addresses the aforementioned needs by providing a 3D-printing UAV that combines advanced aerodynamic design with a parallel kinematic machine (PKM) for precise 3D printing capabilities. Such UAV design would enable on-site repairs, rapid prototyping, and custom part production in locations that are difficult or dangerous for human access.

### SUMMARY

In an exemplary embodiment, a 3D-printing unmanned aerial vehicle (UAV) is described. The UAV comprises a parallel kinematic machine (PKM) mounted on the bottom of a central body of the UAV. The PKM includes a base platform, a moving platform, and a plurality of link members connecting the moving platform to the base platform. The link members are arranged parallel to each other. Printing nozzles are mounted on the moving platform. A control system is provided for controlling the movement of the moving platform for the printing nozzles to deposit material to print a 3D structure at a target area according to a 3D model.

In some embodiments, the link members are telescopic arms.

In some embodiments, the PKM further comprises an attachment system on the base platform that detachably couples the PKM to the bottom of the central body of the UAV.

In some embodiments, the attachment system is further configured to release the PKM from the UAV at a target area where the 3D structure is to be built.

In some embodiments, the base platform includes a supporting structure to anchor the PKM on a surface of the target area when released from the UAV.

In some embodiments, the base platform further comprises a material feed system for feeding material to the printing nozzles. Herein, the material feed system includes a filament spool and a feeder mechanism for each printing nozzle.

In some embodiments, the base platform further comprises a pressurized liquid container containing a liquid, and a spray gun configured to spray the liquid near the target area.

In some embodiments, the base platform is further configured to host a robotic arm that is configured to move objects at the target area.

In some embodiments, the UAV further comprises a first power source that is configured to supply power to the UAV, and a second power source that is configured to supply power to the PKM.

In some embodiments, the second power source includes solar panels.

In some embodiments, the second power source is installed in the PKM.

In some embodiments, the UAV further comprises a processor that is configured to receive the 3D model via a wireless network, and a memory that is configured to store the 3D model.

In some embodiments, the UAV further comprises a plurality of sensors to monitor a printing process for printing the 3D structures. Herein, the sensors include at least two of a proximity sensor, a LiDAR sensor, an accelerometer, a humidity sensor, a temperature sensor, or a camera.

In some embodiments, the control system is further configured to receive sensor data from the sensors, and adjust the printing process for printing the 3D structure based on the sensor data.

In some embodiments, the UAV further comprises a plurality of wings radially extending from the central body, Herein, each wing has U-shape cross section.

In another exemplary embodiment, a non-transitory computer-readable storage medium for storing computer-readable instructions that, when executed by a computer, cause the computer to perform a method, is described. The method comprises receiving, by an unmanned aerial vehicle equipped with a parallel kinematic machine (PKM), data related to a three-dimensional (3D) model of a structure to be printed by the PKM. The method further comprises causing, based on location co-ordinates of a target area, the UAV to fly to the target area to print the 3D structure. The method further comprises printing, by the PKM, the 3D model at the target area. Herein, the PKM is configured to print the 3D structure via print nozzles mounted on a moving platform by controlling a movement of the moving platform based on the 3D model. Further, the PKM is configured to control the movement through a plurality of parallelly-arranged telescopic link members connecting the moving platform to a base platform of the PKM.

In some embodiments, the method of printing the 3D model includes printing the 3D model at the target area while the UAV is hovering at a specified height from a surface of the target area.

In some embodiments, the method of printing the 3D model includes releasing the PKM from the UAV at the target area. The method further comprises printing the 3D model at the target area while the PKM is detached from the UAV and resting on a surface of the target area.

In some embodiments, the method of printing the 3D model includes receiving sensor data from a plurality of sensors mounted on the UAV or the PKM. Herein, the sensor data includes data regarding an environment of the target area. The method further comprises adjusting the printing process based on the sensor data.

In some embodiments, the method of printing the 3D model includes providing, by the UAV, power supply to the PKM from a first power source that is different from a second power source providing power supply to the UAV.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary top perspective diagram of a 3D-printing unmanned aerial vehicle (UAV), according to certain embodiments.

FIG. 2 is an exemplary side perspective diagram of the UAV showing details of a parallel kinematic machine (PKM) mounted on a bottom of a central body thereof, according to certain embodiments.

FIG. 3 is an exemplary top planar diagram of the UAV having wings with curved profile, according to certain embodiments.

FIG. 4 is an exemplary top planar diagram of the UAV having wings with straight profile, according to certain embodiments.

FIG. 5 is an exemplary diagram of the PKM, according to certain embodiments.

FIG. 6 is an exemplary top planar diagram of the UAV with covers for the wings removed to show internal components disposed therein, according to certain embodiments.

FIG. 7 is an exemplary flowchart of a method of printing a 3D model implementing the UAV, according to certain embodiments.

FIG. 8 is an exemplary depiction of implementation of the UAV for a printing operation, according to certain embodiments.

FIG. 9 is an exemplary representation of a wing segment for an analysis of twist due to deviated torsion in the wings of the UAV, according to certain embodiments.

FIG. 10 is an exemplary illustration of static structural analysis for straight wing configuration of the UAV, according to certain embodiments.

FIG. 11 is an exemplary illustration of static structural analysis for curved wing configuration of the UAV, according to certain embodiments.

FIG. 12A is an exemplary illustration setup for harmonic analysis for curved wing configuration of the UAV, according to certain embodiments.

FIG. 12B is an exemplary graph of frequency response in logarithmic format for the harmonic analysis for curved wing configuration, according to certain embodiments.

FIG. 13A is an exemplary illustration setup for harmonic analysis for straight wing configuration of the UAV, according to certain embodiments.

FIG. 13B is an exemplary graph of frequency response in logarithmic format for the harmonic analysis for straight wing configuration, according to certain embodiments.

FIG. 14 is an exemplary graph for battery consumption and motor performance of the UAV, according to certain embodiments.

FIG. 15A is an exemplary depiction of results of 3D printing tests for smooth printing conducted using the UAV using PLA filament, according to certain embodiments.

FIG. 15B is an exemplary depiction of results of 3D printing tests for rough printing with vibration conducted using the UAV using PLA filament, according to certain embodiments.

FIG. 15C is an exemplary depiction of results of 3D printing tests for rough printing with defects conducted using the UAV using PLA filament, according to certain embodiments.

FIG. 16 is an illustration of a non-limiting example of details of computing hardware used in a control system of the UAV, according to certain embodiments.

FIG. 17 is an exemplary schematic diagram of a data processing system used within the control system, according to certain embodiments.

FIG. 18 is an exemplary schematic diagram of a processor used with the control system, according to certain embodiments.

FIG. 19 is an illustration of a non-limiting example of distributed components which may share processing with the control system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a 3D-printing unmanned aerial vehicle (UAV) that combines aerial mobility with advanced 3D printing capabilities. The UAV incorporates a parallel kinematic machine (PKM) enabling precise material deposition for 3D printing tasks in remote or hard-to-access locations. The UAV is designed to autonomously navigate to target areas, perform 3D printing operations either while hovering or after landing, and return to its base upon completion of the task. In some embodiments, the PKM is detachably coupled to the UAV and the UAV can be configured to drop the PKM, or release the PKM from the UAV, at the location where the 3D printing operations are to be performed and collect the PKM at a later time, e.g., after the 3D printing operations are completed. The UAV includes multiple sensors for monitoring the printing process and environmental conditions, allowing for real-time adjustments to ensure print quality. The design of the UAV, including configuration of its wing and the PKM being detachable, provides enhanced stability during flight and printing operations, making it suitable for a wide range of applications in construction, repair, and custom manufacturing in challenging environments.

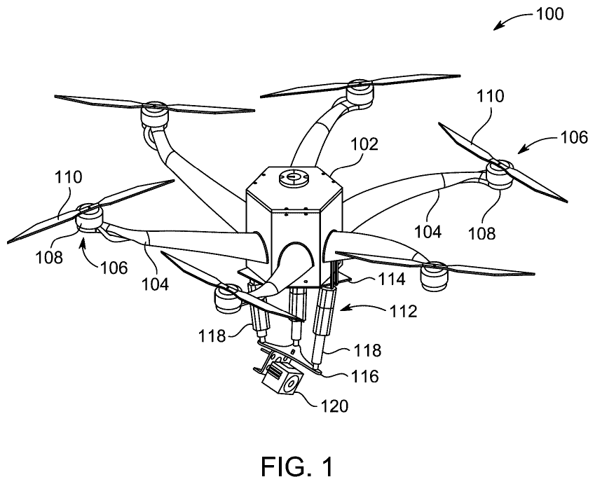

Referring to FIG. 1, illustrated is an exemplary perspective diagram of a 3D-printing unmanned aerial vehicle (UAV) 100. The UAV 100 includes a central body 102 that serves as the main structural component and housing for various systems and components. As depicted in the illustrated example, the central body 102 has a generally hexagonal shape, providing multiple mounting points for other components and optimizing weight distribution. However, it may be contemplated that the central body 102 may have any other suitable shape, such as circular, square, rectangular or the like, without any limitations. The UAV 100 further includes a plurality of wings 104 radially extending from the central body 102. In an example embodiment, the UAV 100 has six wings 104 (as shown). The wings 104 are arranged symmetrically around the central body 102. Further, in the UAV 100, at the distal end of each wing 104, a propulsion unit 106 is mounted. Each wing 104 is designed to provide structural support and house wiring and control mechanisms for propulsion units (as discussed in more detail in the proceeding paragraphs). Herein, each propulsion unit 106 includes a motor 108 and a propeller 110. The motors 108 are designed to provide speed control and the propellers 110 are designed for efficient thrust generation, providing stable flight and hovering capabilities to the UAV 100.

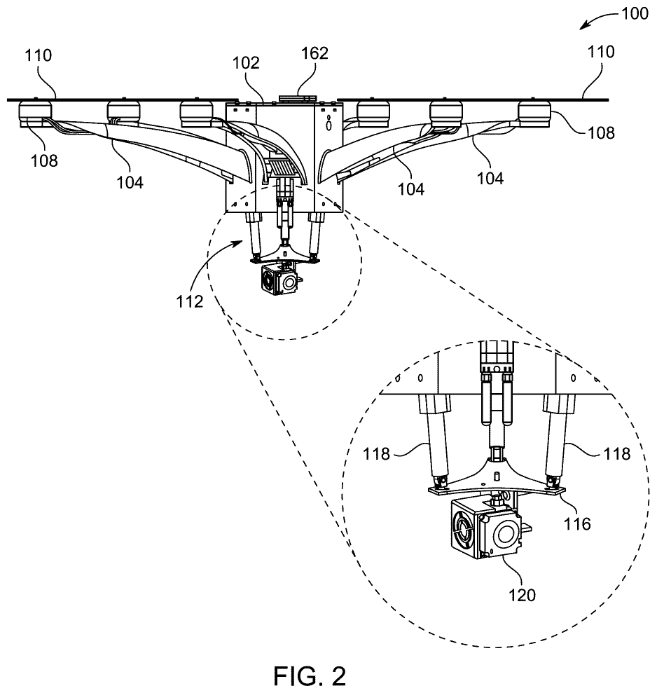

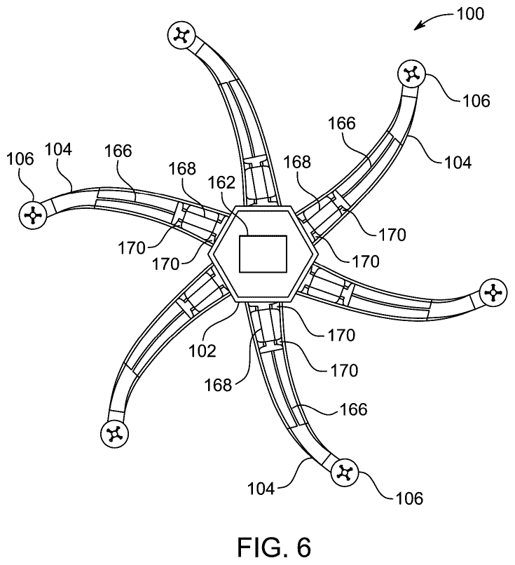

In the present embodiments, each wing 104 has U-shape cross section. FIG. 2 illustrates a side perspective view of the UAV 100, depicting the wing 104 with its U-shaped profile. The U-shaped cross-section of each wing 104 is designed to enhance the structural integrity and stability of the UAV 100. The profile of the wings 104, with the U-shaped cross-section, allows for a higher moment of inertia which increases resistance of the wings 104 to bending and torsion forces during flight and 3D printing operations. The U-shaped cross-section also results in a profile providing an internal channel which can be utilized for various purposes, such as routing cables and potentially housing other components (as discussed later in reference to FIG. 6). In the present implementation, the U-shaped cross-section of the wings 104 may further contribute to the overall stiffness of the structure of the UAV 100, which allows for maintaining stability during precise 3D printing tasks, especially when operating in challenging environmental conditions.

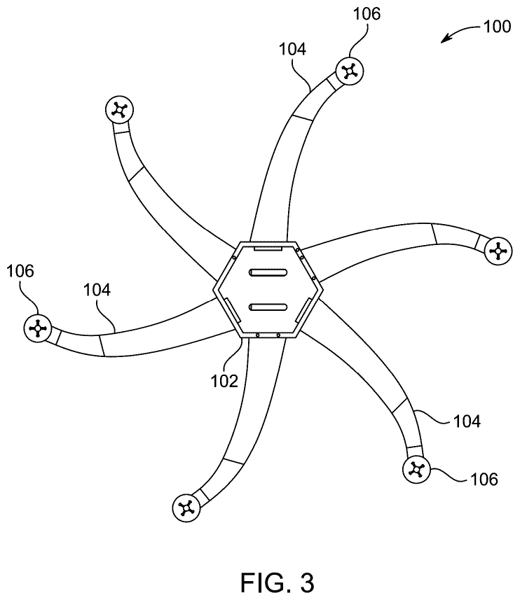

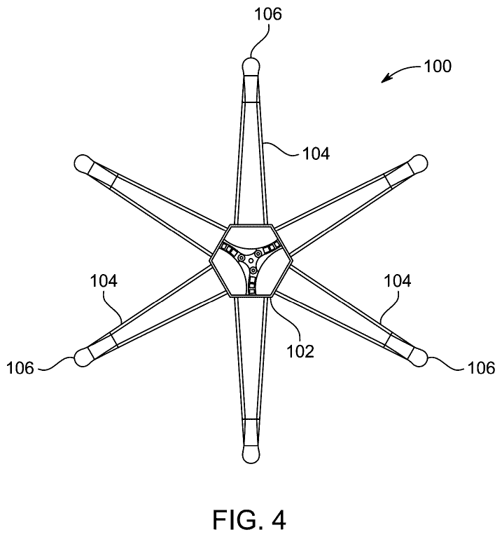

Further, in present embodiments, the wings 104 may be designed to have a particular profile along its length. FIG. 3 illustrate a top view of the UAV 100 with the wings 104 having a substantially curved profile, according to one embodiment. As shown, in this configuration, the central body 102 of the UAV 100 has the hexagonal shape, providing six attachment points for the wings 104. Each wing 104 extends radially from the central body 102 and has the curved profile along its length. The curved profile of the wings 104 is designed to enhance aerodynamic performance and structural stability of the UAV 100. Further, the curved profile of the wings 104 allows for improved distribution of forces during flight and potentially contributes to the overall maneuverability of the UAV 100. FIG. 4 illustrate a top view of the UAV 100 with the wings 104 having a substantially straight profile, according to an alternate embodiment. As shown, in this configuration, the wings 104 extend linearly from each vertex of exemplary hexagonal shape of the central body 102. The straight profile of the wings 104 provides a different approach to structural design and aerodynamics compared to the curved profile of the wings 104 (shown in FIG. 3). Further, the straight profile of the wings 104 may provide advantages in terms of manufacturing simplicity and potentially different flight characteristics compared to the curved wing design.

Referring back to FIG. 1, as shown, the UAV 100 further includes a parallel kinematic machine (PKM) 112. The PKM 112 is mounted on a bottom of the central body 102. In the UAV 100, the PKM 112 is responsible for performing the 3D printing operations. The PKM 112 is designed to provide precise control and movement for the 3D printing operations. As better illustrated in FIG. 2, the PKM 112 includes a base platform 114 that is rigidly attached to the central body 102 of the UAV 100. The base platform 114 serves as the foundation for the PKM 112 and houses various components such as control systems, power sources, and material feed systems (as discussed later in more detail). The PKM 112 also includes a moving platform 116 that is positioned below the base platform 114. The PKM 112 further includes a plurality of link members 118 connecting the moving platform 116 to the base platform 114. The link members 118 are arranged parallel to each other, which is a defining characteristic of parallel kinematic machines. The parallel arrangement of the link members 118 provides high stiffness and low inertia, which allows for precise and stable printing operations.

Further, as illustrated, the PKM 112 includes printing nozzles 120 mounted on the moving platform 116. As better shown in the zoomed-in portion of FIG. 2, the printing nozzles 120 may be arranged in the form of an assembly on the moving platform 116; and hereinafter, sometimes, referred to as printing nozzle assembly 120 without any limitations. The moving platform 116 is designed to carry the printing nozzles 120 to be precisely positioned and oriented in three-dimensional space. The configuration of the PKM 112 allows for a large workspace relative to its size, enabling the printing of larger objects or structures. The parallel arrangement of the link members 118 also distributes the load evenly, enhancing the stability and precision of the printing process. The configuration of the PKM 112 provides high accuracy and repeatability in positioning the printing nozzle assembly 120, which allows for producing high-quality 3D prints, especially in potentially challenging environments where the UAV 100 may operate.

In an embodiment, the link members 118 are telescopic arms. The telescopic arms are designed to extend and retract, allowing for precise control of the length of each link member 118. The telescopic nature of the link members 118 enables a wide range of motion for the moving platform 116, expanding the workspace of the 3D printing system. Each telescopic arm may include nested segments that can slide within one another, driven by actuators such as electric motors or hydraulic systems. The actuators are controlled by the control system of the PKM 112 to adjust the length of each link member 118 independently. This independent control of each link member 118 allows for complex movements of the moving platform 116 in three-dimensional space. The telescopic design also provides a compact form factor when retracted, which can be advantageous for transport and storage of the UAV 100. The use of telescopic arms as link members 118 contributes to the overall precision and flexibility of the 3D printing capabilities of the UAV 100, allowing for accurate material deposition in various orientations and positions.

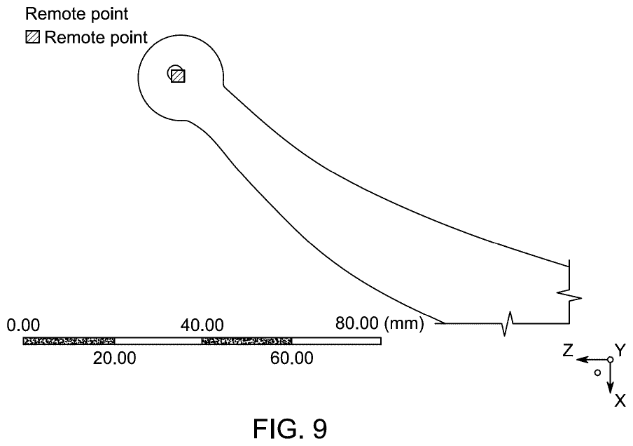

The PKM 112 further includes a control system 126 for controlling the movement of the moving platform 116 for the printing nozzles 120 to deposit material to print a 3D structure at a target area according to a 3D model. That is, the control system 126 is responsible for managing the movement of the moving platform 116 of the PKM 112, enabling the printing nozzles 120 to deposit material and create a 3D structure at a target area according to a predetermined 3D model. The control system 126 may include a processor, memory, and various interfaces (as discussed later in reference to FIGS. 9-12) to communicate with different components of the UAV 100. In particular, herein, the control system 126 includes a processor and a memory. The processor is a central processing unit designed to execute instructions and manage the overall operations of the UAV 100 and the PKM 112. The processor is configured to receive the 3D model via a wireless network. This wireless network capability allows the UAV 100 to receive updated printing instructions or new 3D models remotely, without the need to physically connect to a data source. The wireless network may utilize various protocols such as Wi-Fi, cellular data, or satellite communication, depending on the operational requirements and environment of the UAV 100. The memory of the control system 126 is configured to store the 3D model received by the processor. The stored 3D models in the memory can be accessed by the processor as needed during the printing process.

In general, the wireless network in the UAV 100 may be provided by a communication system, integrated into the UAV 100 to enable data exchange with its base station or control center. The communication system may utilize cloud-based technologies to ensure reliable and secure communication over long distances. The communication system allows for real-time transmission of sensor data, video feeds, and status updates from the UAV 100 to the base station. This enables remote monitoring of the printing process and the overall status of the UAV 100. Further, the communication system allows for the transmission of new instructions, updated 3D models, or command overrides from the base station to the UAV. The UAV 100 is capable of operating in an autopilot mode, where its trajectory and target location (e.g., location where 3D printing operations are to be performed) are pre-programmed using a web-based application. During flight, the position of the UAV 100 is continuously monitored through GPS communication with satellites. All navigation data is stored in the cloud, allowing for post-flight analysis and mission review. The communication system also incorporates redundancies and fail-safes to ensure that control of the UAV 100 can be maintained even in the event of partial communication failure. This may include the ability to switch between different communication protocols or fall back to pre-programmed behaviors if communication is lost.

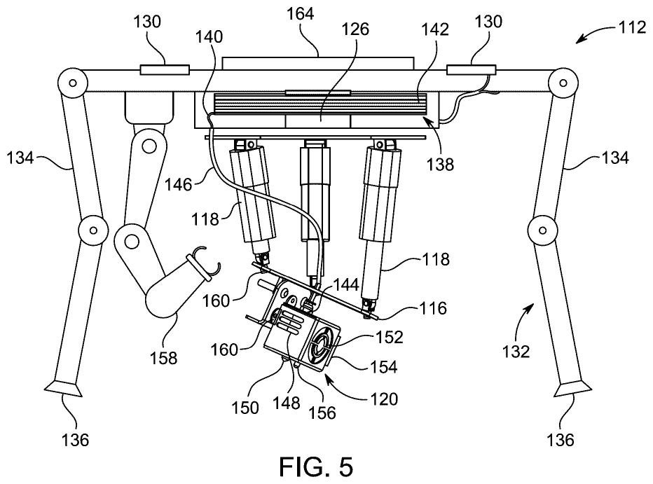

FIG. 5 illustrates a detailed view of the PKM 112. As shown, in some embodiments, the PKM 112 includes an attachment system 130 on the base platform 114 that detachably couples the PKM 112 to the bottom of the central body 102 of the UAV 100. In an example configuration, the attachment system 130 may include a release mechanism with a set of mechanical interfaces that allow for secure fastening of the PKM 112 to the UAV 100 during flight and printing operations, while also enabling the detachment of the PKM 112 when required. In an example, the release mechanism of the attachment system 130 may include alignment pins, grooves, or other features that ensure precise positioning of the PKM 112 relative to the central body 102 of the UAV 100. The release mechanism of the attachment system 130 can be actuated remotely or automatically, allowing for controlled release of the PKM 112 from the UAV 100. The attachment system 130 may also incorporate electrical connectors that establish power and data connections between the PKM 112 and the UAV 100 when attached. These connections enable the transfer of power from power source(s) of the UAV 100 to the PKM 112 and facilitate communication between the UAV 100 and the components of the PKM 112.

In the present implementation, the attachment system 130 is configured to release the PKM 112 from the UAV 100 (i.e., from the bottom of the central body 102 of the UAV 100) at a target area where the 3D structure is to be built. The detachable nature of the attachment system 130 provides flexibility in the deployment and operation of the PKM 112, allowing for scenarios where the PKM 112 can be left at the target area to continue printing operations independently while the UAV 100 returns to its base or performs other tasks. This operation involves a series of coordinated actions, where the UAV 100 first navigates to the target area, then stabilizes its position to ensure that the release mechanism of the attachment system 130 can function effectively. Upon reaching the target area, the attachment system 130 initiates the release process, disengaging the PKM 112 from the central body 102 of the UAV 100. This process is controlled to ensure that the PKM 112 is accurately positioned for the subsequent construction of the 3D structure.

In addition to its release capabilities, the attachment system 130 is further designed to enable the UAV 100 to retrieve the PKM 112 once the printing operation is completed. The UAV 100 can return to the target area where the PKM 112 was left, position itself precisely above the PKM 112, and re-engage the attachment system 130. The attachment system 130 includes a locking mechanism that securely fastens the PKM 112 back to the central body 102 of the UAV 100. This feature allows for the full cycle of deployment, independent operation, and retrieval of the PKM 112, enhancing the versatility and efficiency of the UAV 100 in performing multiple printing tasks across different locations. The attachment system 130 and the UAV 100 may communicate directly with each other to co-ordinate the release of the PKM 112 and/or re-attachment of the PKM 112 to the UAV 100, or they may be configured to receive instructions from the base station to co-ordinate the release and re-attachment.

Further, as illustrated, the base platform 114 includes a supporting structure 132 to anchor the PKM 112 on a surface of the target area when released from the UAV 100. In an example, as illustrated, the supporting structure 132 may include foldable legs 134 with sucker feet 136 at their ends. The foldable legs 134 are designed to extend from a compact, folded position during flight to a deployed position when the PKM 112 is released from the UAV 100. The sucker feet 136 at the end of each foldable leg 134 provide a secure attachment to various surfaces at the target area. The suction mechanism of the sucker feet 136 allows the PKM 112 to maintain a stable position on different types of surfaces, including those that may not be perfectly level or smooth. This anchoring capability enables the PKM 112 to operate independently and maintain printing accuracy even when detached from the UAV 100.

The base platform 114 further includes a material feed system 138 for feeding material to the printing nozzles 120. The material feed system 138 is designed to supply a continuous and controlled flow of a filament 140 (filament/printing material) to enable the 3D printing process. The material feed system 138 includes a filament spool 142 and a feeder mechanism 144 for each printing nozzle 120. The filament spool 142 is a cylindrical structure that holds a coiled length of filament material, such as thermoplastic polymer like PLA (Polylactic Acid), ABS (Acrylonitrile Butadiene Styrene), PETG (Polyethylene Terephthalate Glycol), and Nylon. The choice of material depends on the specific requirements of the printing task, such as strength, flexibility, or temperature resistance. The filament spool 142 is mounted on the base platform 114 in a manner that allows for rotation and unwinding of the filament 140. The feeder mechanism 144 is responsible for pulling the filament 140 from the filament spool 142 through a hose guide 146, and pushing it towards the printing nozzle 120. The feeder mechanism 144 may include a motor-driven gear system that uncoils and pushes the filament 140 at a controlled rate. The speed of the feeder mechanism 144 is coordinated with the movement of the moving platform 116 and the extrusion rate required for the current printing task. The material feed system 138 ensures a reliable and precise supply of the filament 140 to the printing nozzles 120, for maintaining print quality and consistency throughout the 3D printing process.

Furthermore, as illustrated, the printing nozzle assembly 120 of the PKM 112 includes a heating element 148, an extruder 150, and a fan 152. The heating element 148 is the thermal component of the printing nozzle assembly 120 responsible for melting the filament 140 supplied by the material feed system 138. The heating element 148 may typically be enclosed in a thermally conductive block (as shown). The extruder 150 works in conjunction with the feeder mechanism 144 to precisely control the flow of melted filament 140, provided by the heating element, through the printing nozzles 120. The fan 152 is mounted adjacent to the printing nozzles 120, and is configured to cool the extruded filament material after it exits the printing nozzle(s) 120. This rapid cooling helps to solidify the deposited material quickly, which allows for maintaining the shape and structural integrity of the printed object, especially for printing overhanging or bridging features.

In some embodiments, the base platform 114 further includes a pressurized liquid container 154 (as generally represented in FIG. 5) containing a liquid, and a spray gun 156 configured to spray the liquid near the target area. The base platform 114 may include the liquid container 154 and spray gun 156, alternately these items can be hosted on the movable platform 116 instead. The pressurized liquid container 154 is a sealed vessel designed to hold liquid materials under pressure, such as coatings, sealants, or other liquid substances that may be required for the 3D printing process or post-processing of printed structures. The spray gun 156 is a device connected to the pressurized liquid container 154 via a hose or tube. The spray gun 156 is designed to atomize the liquid from the pressurized liquid container 154 and distribute it in a controlled manner near the target area. The operation of the spray gun 156 is coordinated by the control system 126, which can activate and deactivate the spray function as needed during the printing process. This arrangement allows for the application of coatings or treatments to the 3D printed structures, which can enhance their properties, provide protection, or serve other functional purposes.

In some embodiments, the base platform 114 is further configured to host a robotic arm 158 that is configured to move objects at the target area. The robotic arm 158 is a mechanical device designed to perform various manipulation tasks in conjunction with the 3D printing operations of the UAV 100. In an exemplary configuration, the robotic arm 158 is mounted on the base platform 114 in a manner that allows for a wide range of motion and access to the target area. The robotic arm 158 may include multiple joints and segments, each powered by servo motors or actuators that enable precise control of its position and movement. The end of the robotic arm 158 is equipped with an end effector, which may be interchangeable to suit different tasks. This end effector can include grippers, suction cups, or specialized tools designed for specific manipulation tasks. The control system 126 is programmed to coordinate the movements of the robotic arm 158 with the 3D printing process. This coordination allows the robotic arm 158 to perform tasks such as repositioning printed objects, clearing debris from the target area, or placing components within the structure being printed. The robotic arm 158 may also be used to manipulate tools or equipment at the target area, potentially expanding the range of operations that can be performed by the UAV 100 and enhancing the overall capabilities of the UAV 100.

In some embodiments, the UAV 100 further includes a plurality of sensors 160 (as generally represented in FIG. 5) to monitor the printing process for printing the 3D structures. The sensors 160 are strategically placed on various parts of the UAV 100 and the PKM 112 to provide sensor data about the printing process and the surrounding environment. In an example configuration, the sensors 160 include at least two of a proximity sensor, a LiDAR sensor, an accelerometer, a humidity sensor, a temperature sensor, or a camera. Herein, the proximity sensor is used to measure the distance between the printing nozzles 120 and the surface being printed upon, ensuring accurate layer height and overall dimensional accuracy of the printed structure. The LiDAR sensor provides detailed 3D mapping of the target area and the printed structure, allowing for real-time comparison between the intended 3D model and the actual printed object. The accelerometer detects vibrations and movements of the UAV 100 or the PKM 112 during the printing process, for maintaining print quality. The humidity sensor monitors ambient moisture levels, which can affect the properties of certain printing materials. The temperature sensor measures both the ambient temperature and the temperature of the printing nozzles 120, ensuring optimal printing conditions. The camera provides visual feedback of the printing process, allowing for real-time monitoring and post-print inspection.

In the present implementation, the control system 126 is further configured to receive sensor data from the sensors 160. This sensor data is continuously collected and processed by the processor of the control system. The sensor data provides real-time information about the printing conditions, environmental factors, and the progress of the 3D structure being printed. The control system 126 is configured to adjust the printing process for printing the 3D structure based on the sensor data. These adjustments can include modifying the printing speed, adjusting the temperature of the printing nozzles 120, altering the extrusion rate of the printing material, or changing the movement patterns of the PKM 112. For example, if the accelerometer detects excessive vibrations, the control system may adjust the movement of the PKM 112 to minimize the impact on print quality. If the humidity sensor detects high moisture levels, the control system may adjust the printing parameters to compensate for potential changes in material properties. Such ability of the control system to make these real-time adjustments based on sensor data ensures that the UAV 100 can maintain high print quality and adapt to varying environmental conditions during the printing process.

In the present embodiments, the UAV 100 includes a dual power supply system to ensure optimal performance of both the flight systems and the 3D printing mechanisms. The UAV 100 includes a first power source 162 that is configured to supply power to the UAV 100. The first power source 162 is dedicated to powering the flight systems of the UAV 100, including the motors 108 and the control system with its navigation and communication equipment. The first power source 162 is installed in the central body 102 of the UAV 100, or specifically disposed inside the central body 102 (as depicted in FIG. 6), without any limitations. The UAV 100 also includes a second power source 164 (e.g., a battery) that is configured to supply power to the PKM 112 (as generally depicted in FIG. 5). The second power source 164 is specifically designed to meet the power requirements of the PKM 112 and its associated systems, including the printing nozzles 120, the material feed system 138, and the control components of the PKM 112. Herein, the second power source 164 is installed in the PKM 112 (as shown in FIG. 5). This configuration allows the PKM 112 to operate independently when detached from the UAV 100 at the target area. The installation of the second power source 164 within the PKM 112 ensures that the 3D printing operations can continue uninterrupted even when the PKM 112 is separated from the central body 102 of the UAV 100.

In an implementation, the second power source 164 may further include solar panels. The solar panels may be used to recharge the second power source 164. The solar panels are integrated into the design of the UAV 100, potentially mounted on surface of the PKM 112, to harness solar energy and extend the operational time of the printing system. The solar panels of the second power source 164 can continue to generate power for the PKM 112 during daylight hours, potentially extending the duration of printing operations at the target area. Such power system enhances the versatility and operational capabilities of the 3D-printing UAV 100, allowing for extended missions and the ability to perform printing tasks in remote locations without the need for frequent returns to a charging station.

FIG. 6 is an exemplary top planar diagram of the UAV 100 with outer covers for the wings 104 removed to show internal components disposed therein. As illustrated, the UAV 100 may include cables 166 arranged and disposed along the length of each wing 104. These cables 166 connect the propulsion units 106 to the control system housed in the central body 102 of the UAV 100. Additionally, as shown, the UAV 100 may include electronic speed controller (ESC) 168 located in each wing 104, specifically near the junction of each wing 104 and the central body 102. Each ESC 168 may be supported inside the wings 104 by holders 170. Each ESC 168 is configured to regulate the speed of the motor 108 associated with the corresponding wing 104. The internal routing of the cables 166 and the arrangement of ESCs 168 help to organize the electrical components, protect them from external elements, and maintain the aerodynamic profile of the UAV 100.

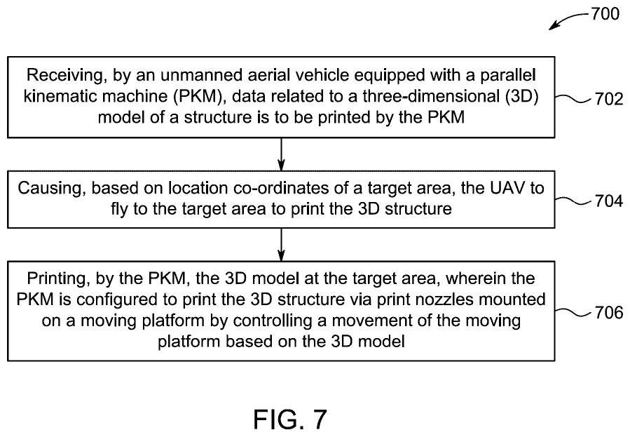

For operational purposes, the UAV 100 includes a non-transitory computer-readable storage medium (which may be the memory, as part of the control system) for storing computer-readable instructions. When executed by a computer (such as, the processor of the control system), these instructions cause the computer to perform a method (as represented by a flowchart in FIG. 7, and referred by reference numeral 700) for 3D printing using the UAV 100. The method 700 comprises several steps that enable the UAV 100 to autonomously carry out 3D printing operations at a target area. These steps are only illustrative, and other alternatives may be considered where one or more steps are added, one or more steps are removed, or one or more steps are provided in a different sequence without departing from the scope of the present disclosure. Various variants disclosed above, with respect to the aforementioned UAV 100 apply mutatis mutandis to the present method 700.

At step 702, the method 700 involves receiving, by the UAV 100 equipped with the PKM 112, data related to a three-dimensional (3D) model of a structure to be printed by the PKM 112. This data is received by the processor of the control system via the wireless network capability of the UAV 100. The 3D model data contains detailed information about the geometry, dimensions, and other characteristics of the structure to be printed or built.

At step 704, the method 700 involves causing, based on location co-ordinates of a target area, the UAV 100 to fly to the target area to print the 3D structure. The control system of the UAV 100 uses the received location coordinates to plan and execute a flight path to the target area. This step utilizes the navigation and propulsion systems of the UAV 100, including the motors 108 and propellers 110, to achieve controlled flight to the specified location.

At step 706, the method 700 involves printing, by the PKM 112, the 3D model at the target area. The PKM 112 is configured to print the 3D structure via the printing nozzles 120 mounted on the moving platform 116. The printing process is achieved by controlling the movement of the moving platform 116 based on the 3D model (i.e., received 3D model data). Herein, the PKM 112 is configured to control the movement through the plurality of parallelly-arranged telescopic link members 118 connecting the moving platform 116 to the base platform 114 of the PKM 112. In particular, the control system 126 executes algorithms that interpret data from the 3D model and translate it into movement instructions for the link members 118 of the PKM 112. These instructions control the extension and retraction of telescopic arm(s) of the link member(s) 118, which in turn determines the position and orientation of the moving platform 116.

In one embodiment, the method 700 includes printing the 3D model at the target area while the UAV 100 is hovering at a specified height from a surface of the target area. In this configuration, the control system of the UAV 100 maintains a stable hover position using the propulsion units 106, including the motors 108 and propellers 110. The specified height is determined based on factors such as the size of the 3D model to be printed, the operational range of the PKM 112, and environmental conditions. While hovering, the PKM 112 remains attached to the central body 102 of the UAV 100 via the attachment system 130. The control system coordinates the hovering stability of the UAV 100 with the precise movements of the PKM 112 to ensure accurate deposition of the printing material through the printing nozzles 120.

In another embodiment, the method 700 of printing the 3D model includes a two-step process where the PKM 112 is detached from the UAV 100. Herein, first, the method 700 involves releasing the PKM 112 from the UAV 100 at the target area. This release is executed using the attachment system 130, which detaches the PKM 112 from the bottom of the central body 102 of the UAV 100. Upon release, the supporting structure 132 of the PKM 112, including the foldable legs 134 and sucker feet 136, deploys to stabilize the PKM 112 on the surface of the target area. Subsequently, the method 700 involves printing the 3D model at the target area while the PKM 112 is detached from the UAV 100 and resting on the surface of the target area. In this configuration, the PKM 112 operates independently, powered by the second power source 164. The control system 126, which may be integrated into the PKM 112 or remain in communication with the detached UAV 100, manages the printing process. The printing nozzles 120 deposit material according to the 3D model, with the movement of the moving platform 116 controlled through the telescopic link members 118. When the printing process may be completed, the detached UAV 100 can come back and pick the PKM 112, with the attachment system 130 configured to lock the PKM 112 back with the central body 102. This approach allows for extended printing operations without requiring the UAV 100 to maintain a prolonged hover, potentially increasing the overall efficiency of the printing task.

Herein, the method 700 of printing the 3D model includes providing, by the UAV 100, power supply to the PKM 112 from the first power source 162 that is different from the second power source 164 providing power supply to the UAV 100. As discussed, the first power source 162 is dedicated to powering the flight systems of the UAV 100, including the motors 108, navigation equipment, and communication systems. This first power source 162 is installed in the central body 102 of the UAV 100. The second power source 164, which is separate and distinct from the first power source 162, is specifically designed to meet the power requirements of the PKM 112 and its associated systems. The second power source 164 is installed within the PKM 112 itself. During the printing operation, the UAV 100 ensures that the PKM 112 receives power from the second power source 164, which may include solar panels for extended operation. Such dual power system allows for detachment of the PKM 112 (as discussed above), and also for optimal energy management ensuring that the power-intensive printing operations do not compromise the flight capabilities of the UAV 100.

The method 700 of printing the 3D model further includes steps for real-time adaptation based on environmental factors. The method 700 involves receiving sensor data from the plurality of sensors 160 mounted on the UAV 100 or the PKM 112. These sensors 160 may include, but are not limited to, proximity sensors, LiDAR sensors, accelerometers, humidity sensors, temperature sensors, and cameras. The sensor data includes data regarding the environment of the target area, such as temperature, humidity, wind speed, and surface conditions. The method 700 further includes adjusting the printing process based on the sensor data. Herein, the control system of the UAV 100 processes the received sensor data and makes real-time adjustments to various printing parameters. These adjustments may include modifying the printing speed, altering the temperature of the heating element 148 in the printing nozzles 120, changing the extrusion rate of the filament 140 through the extruder 150, or adjusting the movement patterns of the moving platform 116 of the PKM 112. For example, if the humidity sensor detects high moisture levels, the control system may adjust the printing parameters to compensate for potential changes in material properties. If the accelerometer detects excessive vibrations, the control system may modify the movement of the PKM 112 to maintain print quality. These real-time adjustments ensure that the UAV 100 can adapt to varying environmental conditions and maintain high print quality throughout the printing process, even in challenging or changing environments.

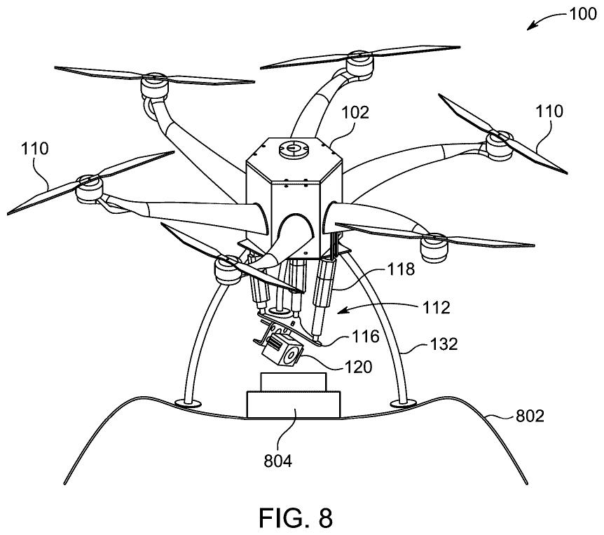

FIG. 8 illustrates an exemplary implementation of the UAV 100 for performing a printing operation. The UAV 100 is shown hovering above a surface 802 at the target area. The PKM 112 is extended below the central body 102 of the UAV 100, positioning the printing nozzles 120 at an appropriate distance from the surface 802. The PKM 112 is actively depositing material to create a 3D structure 804 on the surface 802. The individual telescopic link members 118 of the PKM 112 are extended/retracted to allow for precise control over positioning and orientation of the moving platform 116, and thereby the printing nozzles 120. The propellers 110 of the UAV 100 are in motion, maintaining the stability of the UAV 100 during the printing process. Optionally, the supporting structure 132 is deployed to anchor the PKM 112 on the surface 802 of the target area, providing stability for the printing operation. This configuration showcases the ability of the UAV 100 to perform 3D printing tasks while hovering, to enable operations in locations where landing may not be possible or practical. The control system of the UAV 100 and the control system 126 simultaneously manage the flight stability and the printing operations, and coordinates the movements of the PKM 112 with the positioning of the UAV 100 to ensure accurate material deposition according to the predetermined 3D model.

In general, the control system 126 continuously monitors the position of the moving platform 116 through feedback from the sensors 160, including encoders on the link members 118, to ensure accurate positioning. The control system 126 also regulates the material feed system 138, coordinating the flow of printing material to the printing nozzles 120 with the movement of the moving platform 116. This synchronization ensures that the correct amount of material is deposited at the right locations to build the 3D structure according to the model. The control system can make real-time adjustments to the printing process based on data from various sensors on the UAV 100, such as proximity sensors, accelerometers, and temperature sensors, to maintain print quality and compensate for any environmental factors or unexpected movements of the UAV 100 during the printing process.

In practical implementation, the printing process begins with the generation of a 3D model of the structure to be printed. In particular, once the work to be done is defined, a drawing is executed to produce a .stl file and then a G-Code file. This 3D model is then converted into a series of instructions that the PKM 112 can interpret to build the structure layer by layer. The 3D model can be loaded onto the memory of the control system 126 before the mission, or it can be transmitted to the UAV 100 remotely once it has reached the target location. Once the UAV 100 arrives at the target location, it can execute the printing task in one of two ways. In the first method, the UAV 100 hovers at a specified height above the surface while the PKM 112 deposits material to build the 3D structure. This method is particularly useful for printing on uneven surfaces or in locations where landing is not possible. Alternatively, the UAV 100 can release the PKM 112 onto the surface at the target area. In this case, the PKM 112, equipped with the second power source 164 and the supporting structure 132, continues the printing process while detached from the central body 102 of the UAV 100. This approach allows for extended printing times without requiring the UAV 100 to maintain its position for long periods.

In an example configuration, the UAV 100 is designed to carry a payload of approximately 25 kg, depending on the specific configuration of motors 108 and propellers 110. The selection of motors 108 and propellers 110 can be optimized based on the intended payload and operational requirements. Experimental testing of the motor 108 performance and power consumption has been conducted. The motors 108 were tested on the ground and in flight at various speeds up to 1300 rpm. These tests demonstrated good battery autonomy, with operational times reaching up to 2 hours minimum. After 2 hours of operation, the battery voltage remained at 23V, down from an initial 24V, indicating efficient power management and potential for extended mission durations.

Further, the design of the UAV 100 incorporates precise dimensional specifications to optimize its performance and functionality. The distance between the propellers 110 is set at 15 mm, providing adequate spacing for efficient propulsion. The wings 104 feature an outer fillet with a 3 mm radius and an inner fillet with a 1 mm radius, enhancing structural integrity while maintaining aerodynamic efficiency. The wings 104 of the UAV 100 are constructed with a wall thickness greater than 3 mm, which has been determined through analysis to secure natural frequencies beyond the operational speed of the propeller 110. This design choice contributes to the overall stability and vibration resistance of the UAV 100 during flight and printing operations. The wall thickness of the central body 102 is adjusted to 7 mm, balancing strength and weight considerations. The base platform 114 of the UAV 100 is designed to be 3 mm thick, contributing to the overall lightweight structure. The UAV 100 has a total wingspan of about 480.02 mm, as measured from motor to motor across the central body 102. The design also includes specific features such as a PDB bed, motor screw holes with screw wizards, and switch holes for ease of assembly and maintenance. The central body 102 incorporates first and second floor holders, along with a stand to secure various components. The lower section of the UAV 100 has an increased wall thickness to support the attachment of the parallel kinematic machine (PKM) 112. The wings 104 exhibit a specific angular profile, with an angle of 43.30 degrees relative to the horizontal plane, and a central angle of about 129.90 degrees between adjacent wings, ensuring optimal distribution of thrust and stability during flight and printing operations.

Static and dynamic analyses have been conducted to verify the strength and stability of the UAV 100 structure. These analyses simulate the stress, strain, and total deflection of the wings 104 in both straight and curved configurations. The results indicate that the straight wing configuration experiences less deformation compared to the curved design. A static structural analysis, applying a 55 N upward force at the free end of the wing 104, demonstrates that the straight wing profile experiences less stress compared to the curved profile. Vibration analysis, including harmonic analysis, reveals better dynamic performance in the straight wing shape compared to the curved design. The straight wing configuration exhibits higher natural frequencies, which are outside the operational speeds of the UAV 100. This characteristic helps to minimize vibration issues and avoid resonance with the natural frequencies of the structure. The U-shaped cross-section of the wings 104 is tapered from the assembly of the motor 108 to the base where it connects to the central body 102. This specific shape has been computationally determined to provide high stiffness against bending and torsion forces. The tapered design allows for higher structural frequencies that are separate from the frequencies generated by the motors 108, thereby reducing vibration issues and avoiding problematic resonance with the natural frequencies of the structure.

The structural material selected for the UAV 100 is PolyMide PA612-CF, a carbon fiber reinforced polyamide. This material has been chosen for its optimal balance of strength, weight, and thermal properties. The material properties of PolyMide PA612-CF have been extensively tested according to international standards, including ISO and GB/T methods, with details provided in Table 1 below.

TABLE 1
Structural Properties of PolyMide PA612-CF

| Property | Testing Method | Typical Value | |
|---|---|---|---|
| Density | ISO1183, GB/T1033 | 1.03 g/cm³ at 23° C. | |
| Melt index | 260° C., 2.16 kg | 9.91 g/10 min | |
| Young's modulus (X-Y) | ISO 527, GB/T 1040 | 4735.7 ± 87.8 | MPa |
| Young's modulus (Z) | ISO 527, GB/T 1040 | 2085.8 ± 91.7 | MPa |
| Tensile strength (X-Y) | ISO 527, GB/T 1040 | 86.0 ± 0.9 | MPa |
| Tensile strength (Z) | ISO 527, GB/T 1040 | 29.9 ± 2.1 | MPa |
| Elongation at | ISO 527, GB/T 1040 | 2.8 ± 0.1% | |
| break (X-Y) | | | |
| Elongation at break (Z) | ISO 527, GB/T 1040 | 1.7 ± 0.1% | |
| Bending modulus (X-Y) | ISO 178, GB/T 9341 | 4331.2 ± 90.0 | MPa |
| Bending modulus (Z) | ISO 178, GB/T 9341 | NA | |
| Bending strength (X-Y) | ISO 178, GB/T 9341 | 125.1 ± 2.6 | MPa |
| Bending strength (Z) | ISO 178, GB/T 9341 | NA | |
| Charpy impact | ISO 179, GB/T 1043 | 6.8 ± 0.3 | kJ/m² |
| strength (X-Y) | | | |

| | | |
|---|---|---|
| Charpy impact | ISO 179, GB/T 1043 | NA |
| strength (Z) | | |

Further, the UAV 100 utilizes U7-V2.0 Power Type UAV Motor KV490 for propulsion. These motors are specifically designed for high-performance UAV applications, providing a thrust force suitable for the operational requirements of the UAV 100. Details of the utilized motors are provided in Table 2 below. Each motor has a specified thrust of 5600 gf, which converts to 54.936 N of force. This thrust capacity ensures that the UAV 100 can effectively carry its payload and maintain stability during both flight and 3D printing operations. The motors operate at a frequency of 113.33 Hz, calculated from the maximum RPM of 6800. This operating frequency is derived using the formula: RPM: 60=Hz. The thrust force of the motors can be adjusted from 50% to 100% of the maximum capacity, providing a range of 2720 gf to 5600 gf (26.68 N to 54.936 N). This adjustable thrust allows for precise control of the UAV 100 during various phases of operation, from takeoff and landing to hovering for 3D printing tasks. The high thrust-to-weight ratio of these motors contributes to the overall efficiency and maneuverability of the UAV 100 system.

TABLE 2
Performance data for Motor

| Throttle | Voltage | Current | Power | Thrust | | Efficiency |
|---|---|---|---|---|---|---|
| (%) | (V) | (A) | (W) | (g) | RPM | (g/W) |
| 50% | 16.8 | 420 | 2720 | 4900 | 6480 | 6.48 |
| 65% | 29.5 | 738 | 3850 | 5400 | 5220 | 5.22 |
| 75% | 40 | 1000 | 4510 | 6000 | 4510 | 4.51 |
| 85% | 50 | 1250 | 5080 | 6300 | 4060 | 4.06 |
| 100% | 62 | 1550 | 5600 | 6800 | 3610 | 3.61 |

FIG. 9 illustrates a visual representation of a wing segment for an analysis of twist due to deviated torsion in the wings 104 of the UAV 100. Table 3 below presents deformation and rotation data for both straight and curved wing configurations. The analysis focuses on a remote point, to measure the structural response to torsional forces. The data in Table 3 indicates that the straight wing configuration experiences less overall deformation compared to the curved design. Specifically, the deformation sum for the straight wing is 10.103 mm, while the curved wing exhibits a larger deformation of 17.295 mm. The rotational data similarly shows reduced twisting in the straight wing design. This analysis supports the conclusion that the straight wing shape offers superior resistance to torsional deformation, contributing to the overall structural stability and performance of the UAV 100 during flight and 3D printing operations.

TABLE 3
Deformation and rotation data for straight
and curved wing configurations

| Structure | Straight | Curved |
|---|---|---|
| Location of remote point | [0.16022, 122.59, | [−162.64, 130, |
| | 487.364] | 490.89] |
| Deformation X in mm | 2.592e−002 | −1.8039 |
| Deformation Y in mm | 9.9428 | 16.852 |
| Deformation Z in mm | −1.7947 | −3.4446 |
| Deformation sums in mm | 10.103 | 17.295 |
| Rotation X in degrees | −4.721 | −3.0996 |
| Rotation Y in degrees | 1.6517e−002 | −0.69317 |
| Rotation Z in degrees | 6.5225e−002 | −5.4804 |

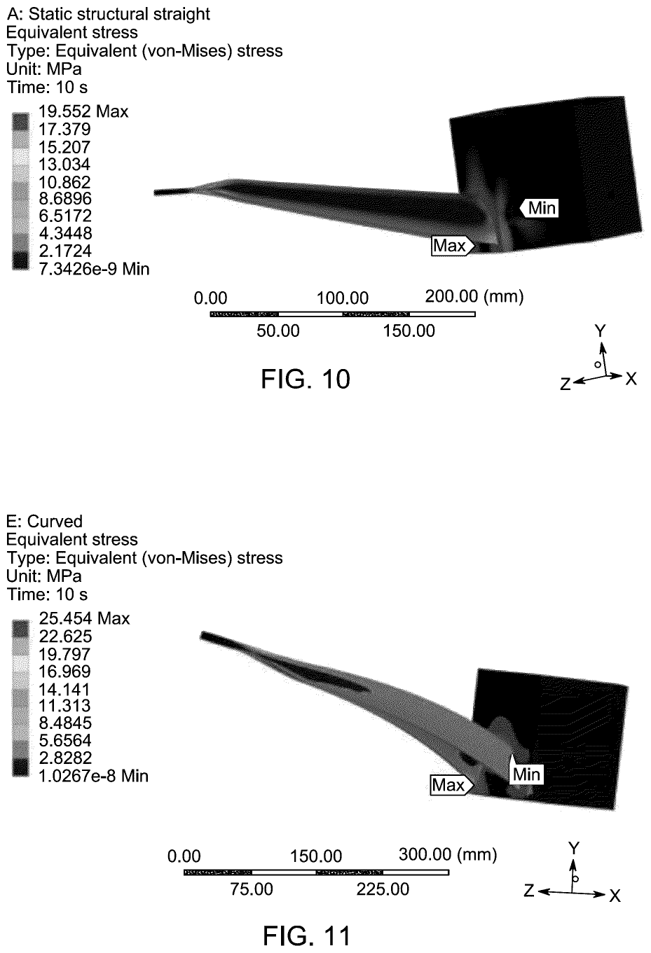

FIGS. 10 and 11 illustrate the static structural analysis results for the wings 104 of the UAV 100, comparing straight and curved wing configurations under an upward force of 55 N applied at the free end. FIG. 10 depicts the equivalent stress distribution in the straight wing structure. The stress analysis, based on von Mises stress criteria, shows a maximum stress of 19.552 MPa occurring near the junction of the wing and the central body. As shown, the straight wing exhibits a relatively uniform stress distribution along its length, with stress concentrations primarily at the root. FIG. 11 depicts the equivalent stress distribution in the curved wing structure. The curved configuration experiences a higher maximum stress of 25.464 MPa, also concentrated near the wing-body junction. The stress distribution in the curved wing shows more variation along the wing's length, with higher stress levels extending further into the wing structure compared to the straight configuration. The comparison between these two configurations demonstrates that the straight wing structure experiences lower peak stresses and a more favorable stress distribution under the applied load, providing potentially greater resistance to deformation during operations of the UAV 100.

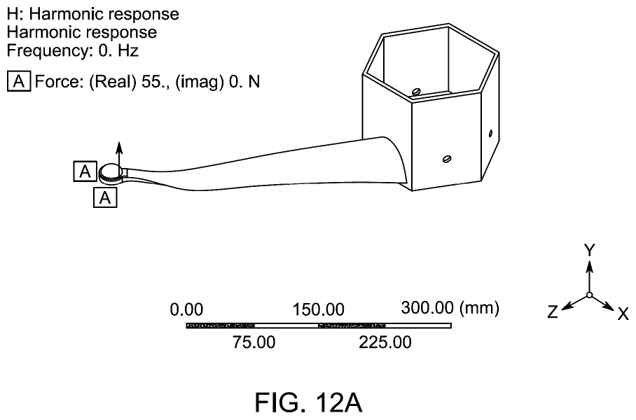

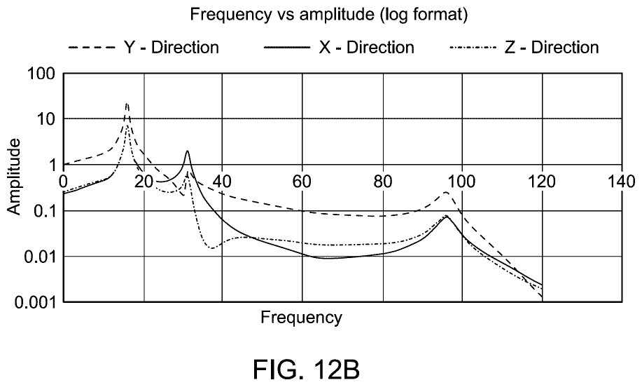

FIGS. 12A and 12B illustrate vibration analysis conducted on the curved wing configuration of the UAV 100. FIG. 12A depicts the setup for harmonic analysis for a curved wing, as attached to a section of the central body of the UAV 100. A harmonic force of 55 N is applied at the free end of the wing, simulating dynamic loading conditions that the UAV 100 may experience during operation. FIG. 12B presents a graph of the frequency response analysis in logarithmic format. The graph shows the amplitude of vibration in the X (lateral), Y (vertical), and Z (longitudinal) directions across a range of frequencies. The X-axis represents the frequency, while the Y-axis shows the amplitude of vibration on a logarithmic scale. The frequency response curves indicate several resonant peaks, with the most prominent occurring at lower frequencies, particularly in the Y-direction (vertical). The graph demonstrates that the wing structure exhibits different vibrational characteristics in each direction, with the vertical direction showing the highest amplitudes overall.

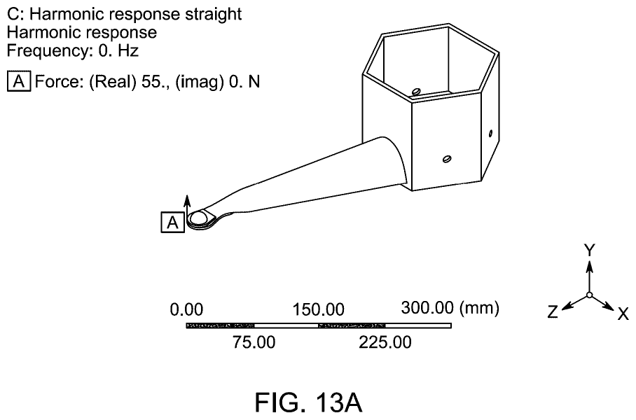

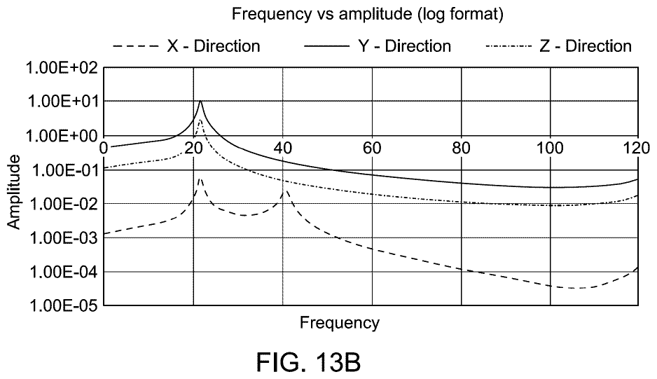

FIGS. 13A and 13B illustrate vibration analysis conducted on the straight wing configuration of the UAV 100. FIG. 13A depicts the setup for harmonic analysis for a straight wing, as attached to a section of the central body of the UAV 100. A harmonic force of 55 N is applied at the free end of the wing, simulating dynamic loading conditions that the UAV 100 may experience during operation. FIG. 13B presents a graph of the frequency response analysis in logarithmic format. The graph shows the amplitude of vibration in the X (lateral), Y (vertical), and Z (longitudinal) directions across a range of frequencies. The X-axis represents the frequency, while the Y-axis shows the amplitude of vibration on a logarithmic scale. The frequency response curves indicate several resonant peaks, with the most prominent occurring at higher frequencies compared to the curved wing configuration. The graph demonstrates that the straight wing structure exhibits different vibrational characteristics in each direction, with the Y and Z directions showing similar amplitudes and the X direction showing lower amplitudes overall. The analysis concludes that the straight shape demonstrates better dynamic performance compared to the curved one, with higher natural frequencies that are outside the operation speeds of the UAV 100.

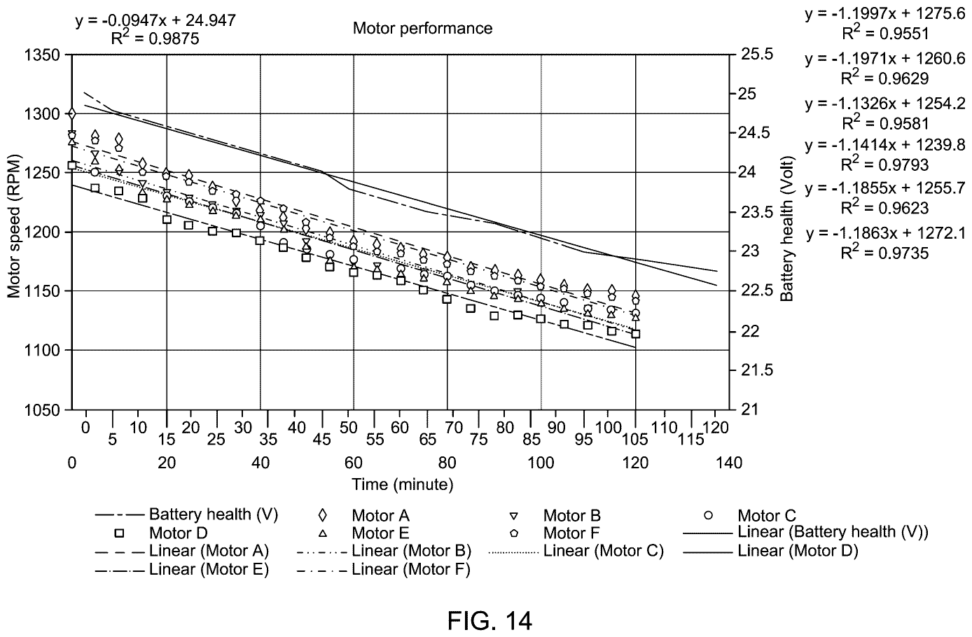

FIG. 14 illustrates a graph for battery consumption and motor performance of the UAV 100. The graph displays data from a test conducted on the motors 108 and power supply system of the UAV 100, both on the ground and in-flight conditions. The X-axis represents time in minutes, extending up to 140 minutes (2 hours and 20 minutes). The primary Y-axis shows motor speed in RPM, while the secondary Y-axis indicates battery health in volts. The graph includes performance curves for six motors (labeled A through F) and the overall battery health. The performance of each motor is represented by a distinct lien pattern and plotted as both individual data points and a linear trendline. The battery health is depicted with its own linear trendline. The test results indicate that the motors 108 maintain speeds between approximately 1300 RPM at the start of the test to around 1100 RPM after 120 minutes of operation. The battery voltage shows a gradual decline from an initial 24V to approximately 23V after 120 minutes of use, indicating efficient power management and good battery longevity. These experimental results confirm capability of the UAV 100 to operate continuously for at least 2 hours, with the potential for even longer duration.

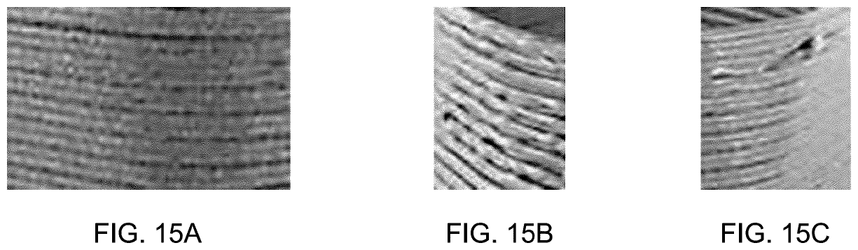

FIGS. 15A, 15B, and 15C illustrate the results of 3D printing tests conducted with the UAV 100 using PLA filament. FIG. 15A shows the outcome of smooth printing, characterized by even and consistent layer deposition. This result is achieved when the UAV 100 is stable and printing parameters are optimized. FIGS. 15B and 15C depict rough printing with visible vibration effects and defects, respectively. These imperfections are the result of two identified issues: fast printing due to power limitations, which causes vibrations in the layer build-up; and incorrect jerk movements of the UAV 100 during printing. The fast printing issue can be mitigated by reducing the print speed and implementing an independent battery system for the printing mechanism. The problems caused by UAV 100 instability can be effectively eliminated by securing the UAV 100 in a fixed position at the printing site. These test results highlight the importance of stable positioning and optimized power management in achieving high-quality 3D prints with the UAV 100 system.

The UAV 100 of the present disclosure provides an approach to remote and on-site additive manufacturing. The UAV 100 combines the mobility and versatility of a drone with the precision and capabilities of a parallel kinematic machine for 3D printing. This integration allows for the execution of complex printing tasks in hard-to-reach locations, for applications in fields such as infrastructure repair, disaster response, and remote construction. The design of the UAV 100, including six wings 104 with a U-shaped cross-section and a detachable PKM 112, provides a stable platform for both flight and printing operations, ensuring high-quality output even in challenging environments.

The UAV 100 employs an advanced communication system for autonomous operation. The flight trajectory and target location are pre-programmed using a web-based application, enabling the UAV 100 to operate in autopilot mode. The position of the UAV 100 is continuously monitored through GPS communication with satellites. All navigation data is stored in cloud-based systems, allowing for real-time tracking and post-mission analysis. This communication infrastructure ensures precise navigation to the target area and facilitates remote monitoring and control of the 3D printing operations.

Further, the material feed system 138 of the UAV 100 is designed to accommodate various fusion deposition materials (FDM), including flexible and jelly-like substances. The system is compatible with common 3D printing filaments such as PLA, ABS, PETG, and Nylon. Additionally, the pressurized liquid container 154 and spray gun 156 allow for the application of various coatings on the target surface. As discussed, the PKM 112 in the UAV 100 incorporates multiple functions beyond 3D printing. For instance, the PKM 112 may incorporate a camera (as part of the sensors 160) to serve dual purposes of monitoring the printing process and inspecting damaged areas, with the capability to transmit images to the base station or cloud for analysis and repair planning. The base platform 114 of the PKM 112 is designed as a universal sub-platform to accommodate various tools for different functions such as painting, spraying, and object manipulation. The power system of the UAV 100 incorporates rechargeable batteries and solar panels integrated into the wings 104, enabling extended operation without the need to return to the base station for battery replacement.

The UAV 100 provides several advantages over existing solutions. The use of telescopic link members 118 in the PKM 112 allows for a larger workspace and more precise control of the printing nozzles 120 compared to traditional robotic arm configurations. The ability to detach the PKM 112 from the UAV 100 at the target area provides flexibility in operation, allowing for extended printing sessions without the need for continuous drone presence. The dual power source system, with a separate second power source 164 for the PKM 112, allows for such detachment and further ensures that printing operations do not compromise flight capabilities. Additionally, the integration of multiple sensors 160 and real-time adjustment capabilities enables the UAV 100 to adapt to varying environmental conditions, maintaining print quality in diverse settings. The modular design of the base platform 114 further expands the functionality of the UAV 100 beyond 3D printing, allowing for tasks such as spraying, inspection, and object manipulation with the robotic arm 158.

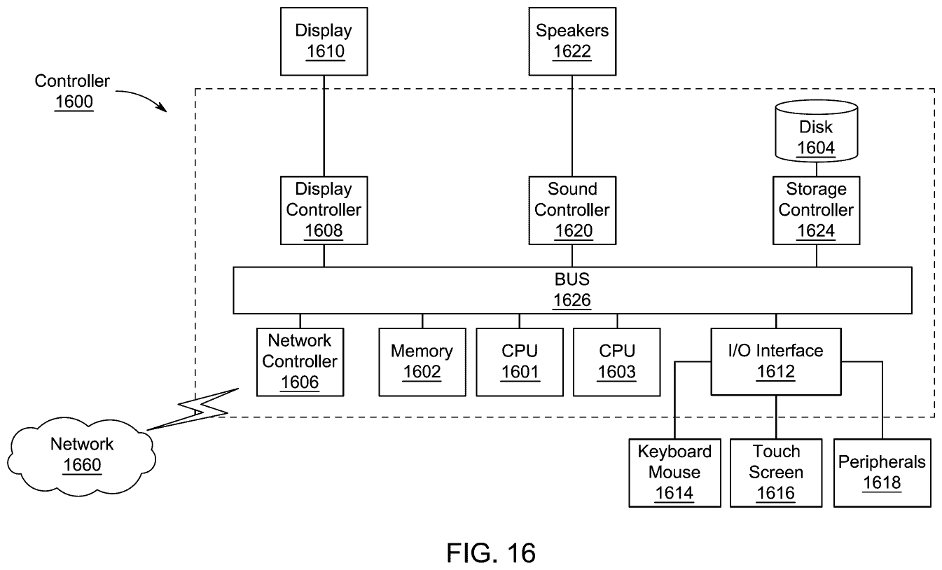

Next, further details of the hardware description of a computing environment according to exemplary embodiments is described with reference to FIG. 16. In FIG. 16, a controller 1600 is described is representative of the control system of the UAV 100, in which the controller 1600 is a computing device which includes a CPU 1601 which performs the processes described above/below. The process data and instructions may be stored in memory 1602. These processes and instructions may also be stored on a storage medium disk 1604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1601, 1603 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1601 or CPU 1603 may be a Xenon or Core processor from Intel of America or an Opteron processor from AMD of America, or may be other processor types that would be recognized by one of ordinary skill in the art. Alternatively, the CPU 1601, 1603 may be implemented on an FPGA, ASIC, PLD or using discrete logic circuits, as one of ordinary skill in the art would recognize. Further, CPU 1601, 1603 may be implemented as multiple processors cooperatively working in parallel to perform the instructions of the inventive processes described above.

The computing device in FIG. 16 also includes a network controller 1606, such as an Intel Ethernet PRO network interface card from Intel Corporation of America, for interfacing with network 1660. As can be appreciated, the network 1660 can be a public network, such as the Internet, or a private network such as an LAN or WAN network, or any combination thereof and can also include PSTN or ISDN sub-networks. The network 1660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1608, such as a NVIDIA GeForce GTX or Quadro graphics adaptor from NVIDIA Corporation of America for interfacing with display 1610, such as a Hewlett Packard HPL2445w LCD monitor. A general purpose I/O interface 1612 interfaces with a keyboard and/or mouse 1614 as well as a touch screen panel 1616 on or separate from display 1610. General purpose I/O interface also connects to a variety of peripherals 1618 including printers and scanners, such as an OfficeJet or DeskJet from Hewlett Packard.

A sound controller 1620 is also provided in the computing device such as Sound Blaster X-Fi Titanium from Creative, to interface with speakers/microphone 1622 thereby providing sounds and/or music.

The general purpose storage controller 1624 connects the storage medium disk 1604 with communication bus 1626, which may be an ISA, EISA, VESA, PCI, or similar, for interconnecting all of the components of the computing device. A description of the general features and functionality of the display 1610, keyboard and/or mouse 1614, as well as the display controller 1608, storage controller 1624, network controller 1606, sound controller 1620, and general purpose I/O interface 1612 is omitted herein for brevity as these features are known.

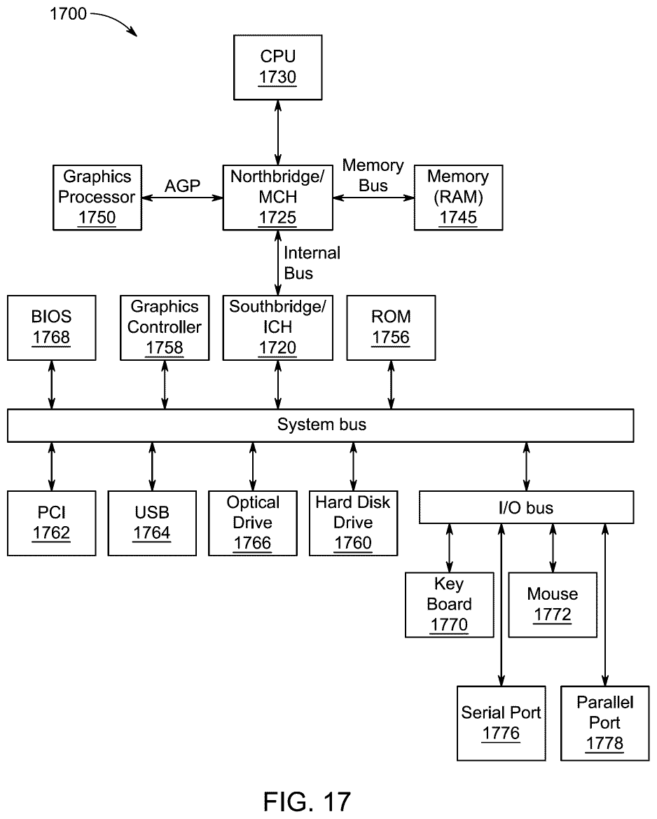

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 17.

FIG. 17 shows a schematic diagram of a data processing system, according to certain embodiments, for performing the functions of the exemplary embodiments. The data processing system is an example of a computer in which code or instructions implementing the processes of the illustrative embodiments may be located.

In FIG. 17, data processing system 1700 employs a hub architecture including a north bridge and memory controller hub (NB/MCH) 1725 and a south bridge and input/output (I/O) controller hub (SB/ICH) 1720. The central processing unit (CPU) 1730 is connected to NB/MCH 1725. The NB/MCH 1725 also connects to the memory 1745 via a memory bus, and connects to the graphics processor 1750 via an accelerated graphics port (AGP). The NB/MCH 1725 also connects to the SB/ICH 1720 via an internal bus (e.g., a unified media interface or a direct media interface). The CPU Processing unit 1730 may contain one or more processors and even may be implemented using one or more heterogeneous processor systems.

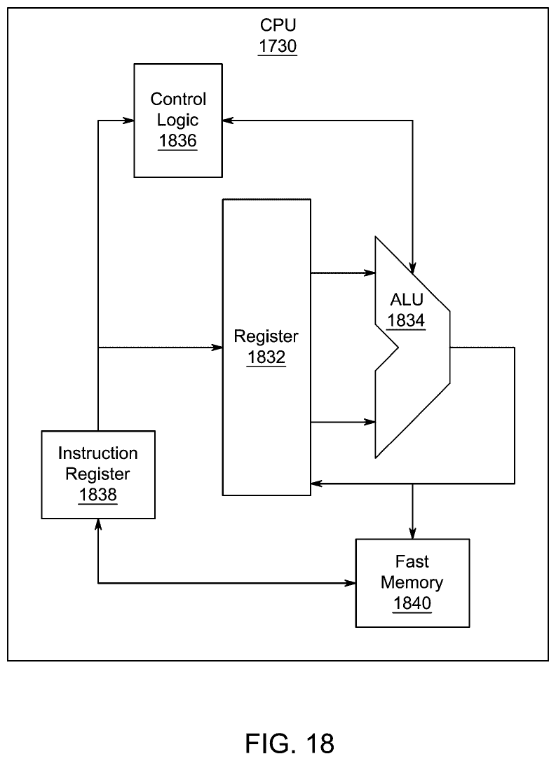

For example, FIG. 18 shows one implementation of CPU 1730. In one implementation, the instruction register 1838 retrieves instructions from the fast memory 1840. At least part of these instructions are fetched from the instruction register 1838 by the control logic 1836 and interpreted according to the instruction set architecture of the CPU 1730. Part of the instructions can also be directed to the register 1832. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1834 that loads values from the register 1832 and performs logical and mathematical operations on the loaded values according to the instructions. The results from these operations can be feedback into the register and/or stored in the fast memory 1840. According to certain implementations, the instruction set architecture of the CPU 1730 can use a reduced instruction set architecture, a complex instruction set architecture, a vector processor architecture, a very large instruction word architecture. Furthermore, the CPU 1730 can be based on the Von Neuman model or the Harvard model. The CPU 1730 can be a digital signal processor, an FPGA, an ASIC, a PLA, a PLD, or a CPLD. Further, the CPU 1730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 17, the data processing system 1700 can include that the SB/ICH 1720 is coupled through a system bus to an I/O Bus, a read only memory (ROM) 1756, universal serial bus (USB) port 1764, a flash binary input/output system (BIOS) 1768, and a graphics controller 1758. PCI/PCIe devices can also be coupled to SB/ICH 1788 through a PCI bus 1762.

The PCI devices may include, for example, Ethernet adapters, add-in cards, and PC cards for notebook computers. The Hard disk drive 1760 and CD-ROM 1766 can use, for example, an integrated drive electronics (IDE) or serial advanced technology attachment (SATA) interface. In one implementation the I/O bus can include a super I/O (SIO) device.

Further, the hard disk drive (HDD) 1760 and optical drive 1766 can also be coupled to the SB/ICH 1720 through a system bus. In one implementation, a keyboard 1770, a mouse 1772, a parallel port 1778, and a serial port 1776 can be connected to the system bus through the I/O bus. Other peripherals and devices that can be connected to the SB/ICH 1720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

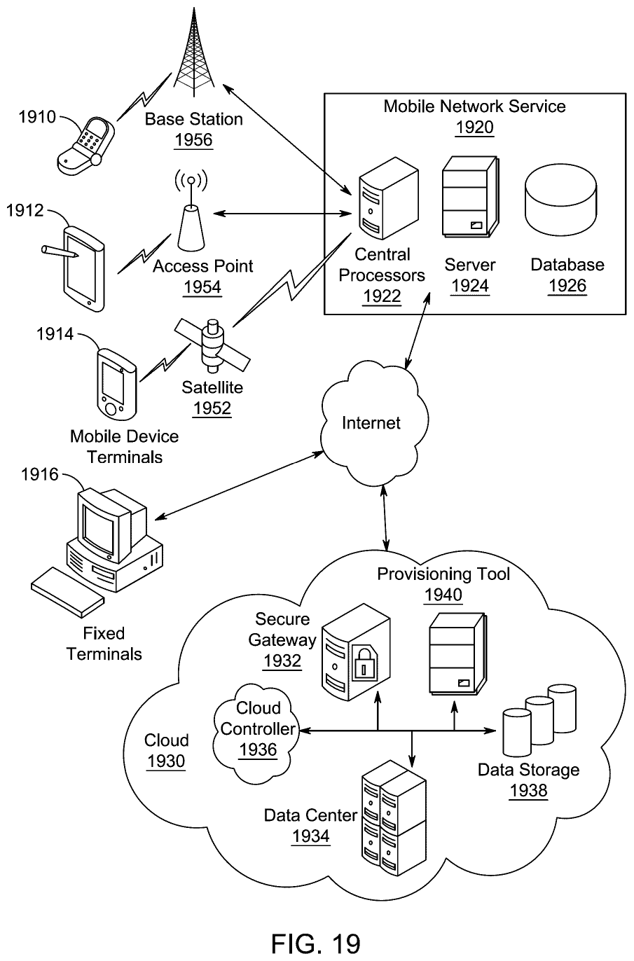

The functions and features described herein may also be executed by various distributed components of a system. For example, one or more processors may execute these system functions, wherein the processors are distributed across multiple components communicating in a network. The distributed components may include one or more client and server machines, such as cloud 1930 including a cloud controller 1936, a secure gateway 1932, a data center 1934, data storage 1938 and a provisioning tool 1940, and mobile network services 1920 including central processors 1922, a server 1924 and a database 1926, which may share processing, as shown by FIG. 19, in addition to various human interface and communication devices (e.g., display monitors 1916, smart phones 1910, tablets 1912, personal digital assistants (PDAs) 1914). The network may be a private network, such as a LAN, satellite 1952 or WAN 1954, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A 3D-printing unmanned aerial vehicle (UAV), the UAV comprising:
a parallel kinematic machine (PKM) mounted on the bottom of a central body of the UAV, wherein the PKM includes:
a base platform;
a moving platform;
a plurality of link members connecting the moving platform to the base platform, the link members being arranged parallel to each other;
printing nozzles mounted on the moving platform; and
a control system for controlling the movement of the moving platform for the printing nozzles to deposit material to print a 3D structure at a target area according to a 3D model.

2. The UAV of claim 1, wherein the link members are telescopic arms.

3. The UAV of claim 1, wherein the PKM further comprises:
an attachment system on the base platform that detachably couples the PKM to the bottom of the central body of the UAV.

4. The UAV of claim 3, wherein the attachment system is further configured to release the PKM from the UAV at a target area where the 3D structure is to be built.

5. The UAV of claim 3, wherein the base platform includes a supporting structure to anchor the PKM on a surface of the target area when released from the UAV.

6. The UAV of claim 1, wherein the base platform further comprises:
a material feed system for feeding material to the printing nozzles, wherein the material feed system includes a filament spool and a feeder mechanism for each printing nozzle.

7. The UAV of claim 1, wherein the base platform further comprises:
a pressurized liquid container containing a liquid, and
a spray gun configured to spray the liquid near the target area.

8. The UAV of claim 1, wherein the base platform is further configured to host a robotic arm that is configured to move objects at the target area.

9. The UAV of claim 1 further comprising:
a first power source that is configured to supply power to the UAV; and
a second power source that is configured to supply power to the PKM.

10. The UAV of claim 9, wherein the second power source includes solar panels.

11. The UAV of claim 9, wherein the second power source is installed in the PKM.

12. The UAV of claim 1 further comprising:
a processor that is configured to receive the 3D model via a wireless network; and
a memory that is configured to store the 3D model.

13. The UAV of claim 1 further comprising:
a plurality of sensors to monitor a printing process for printing the 3D structures, wherein the sensors include at least two of a proximity sensor, a LiDAR sensor, an accelerometer, a humidity sensor, a temperature sensor, or a camera.

14. The UAV of claim 13, wherein the control system is further configured to:
receive sensor data from the sensors, and
adjust the printing process for printing the 3D structure based on the sensor data.

15. The UAV of claim 1 further comprising:
a plurality of wings radially extending from the central body, wherein each wing has U-shape cross section.

16. A non-transitory computer-readable storage medium for storing computer-readable instructions that, when executed by a computer, cause the computer to perform a method, the method comprising:
receiving, by an unmanned aerial vehicle (UAV) equipped with a parallel kinematic machine (PKM), data related to a three-dimensional (3D) model of a structure to be printed by the PKM;
causing, based on location co-ordinates of a target area, the UAV to fly to the target area to print the 3D structure; and
printing, by the PKM, the 3D model at the target area, wherein the PKM is configured to print the 3D structure via print nozzles mounted on a moving platform by controlling a movement of the moving platform based on the 3D model, wherein the PKM is configured to control the movement through a plurality of parallelly-arranged telescopic link members connecting the moving platform to a base platform of the PKM.

17. The computer-readable storage medium of claim 16, wherein the method of printing the 3D model includes:
printing the 3D model at the target area while the UAV is hovering at a specified height from a surface of the target area.

18. The computer-readable storage medium of claim 16, wherein the method of printing the 3D model includes:
releasing the PKM from the UAV at the target area, and
printing the 3D model at the target area while the PKM is detached from the UAV and resting on a surface of the target area.

19. The computer-readable storage medium of claim 16, wherein the method of printing the 3D model includes:
receiving sensor data from a plurality of sensors mounted on the UAV or the PKM, wherein the sensor data includes data regarding an environment of the target area, and
adjusting the printing process based on the sensor data.

20. The computer-readable storage medium of claim 16, wherein the method of printing the 3D model includes:
providing, by the UAV, power supply to the PKM from a first power source that is different from a second power source providing power supply to the UAV.
